(19) United States
(12) Patent Application Publication
(10) Pub. No.: US 2018/0196482 A1
(43) Pub. Date: Jul. 12, 2018

(54) LIQUID COOLING DEVICE

(71) Applicant: AURAS Technology Co., Ltd., New Taipei City (TW)

(72) Inventors: AN-CHIH WU, New Taipei City (TW); MU-SHU FAN, New Taipei City (TW); CHIEN-YU CHEN, New Taipei City (TW)

(21) Appl. No.: 15/437,815

(22) Filed: Feb. 21, 2017

(30) Foreign Application Priority Data
Jan. 6, 2017 (TW) 106100438

(51) Int. Cl. G06F 1/20

(52) U.S. Cl. CPC G06F 1/20

(57) ABSTRACT

A liquid cooling device is provided. The materials of the conduits of the liquid cooling device are improved and specially designed. After the conduit is bent, twisted or retracted, the joint between a water-cooling head or a water-cooling radiator and the conduit is maintained in the secure connection state. Moreover, the materials of the conduits meet the environmental regulations.

### FIELD OF THE INVENTION

The present invention relates to a liquid cooling device, and more particularly to a liquid cooling device with an improved conduit structure.

### BACKGROUND OF THE INVENTION

FIG. 1A schematically illustrates the architecture of a conventional liquid cooling device. FIG. 1B is a schematic side view illustrating a portion of the conventional liquid cooling device. As shown in FIG. 1A, the liquid cooling device 1 comprises a water-cooling head 2, a water-cooling radiator 3 and plural conduits. A circulation loop is constituted by the water-cooling head 2, the water-cooling radiator 3 and the plural conduits collaboratively. Moreover, a working liquid is filled in the circulation loop. The water-cooling head 2 is in contact with a heat source such as a central processing unit (CPU), a graphics processing unit (GPU), a chip or any other comparable device. After the heat from the heat source is absorbed by the water-cooling head 2, the heat is transferred to the water-cooling radiator 3 through the working liquid within the conduit 41. The water-cooling radiator 3 is responsible for heat exchange. After the working liquid is transferred through the water-cooling radiator 3, the temperature of the working liquid is decreased. Then, the cooled working liquid is transferred back to the water-cooling head 2 through the conduit 42. Then, the next circulation cycle of the working liquid is performed.

For example, the liquid cooling device 1 is installed on a case of a host or a server. For increasing flexibility of installing the liquid cooling device 1 or temporarily adjusting the location of the liquid cooling device 1 for installing or replacing other components of the host, the conduits 41 and 42 of the liquid cooling device 1 usually have long or crooked pipelines. The commercially available conduits are usually referred as coiled pipes. As shown in FIGS. 1A and 1B, the coil pipes are hollow pipes with wavy walls along the axial direction. These coiled pipes can be crooked. However, there are still some drawbacks.

Firstly, if the coiled pipes are made of rigid materials, the rigid coiled pipes cannot be bent and thus the problem of blocking the water path is avoided. However, since the rigid materials of the coiled pipes are too hard, the joints of the coiled pipes are subjected to small shift if the coiled pipes are bent several times. As the number of times of bending the coiled pipes increases, the joints are easily in the loose state.

Secondly, the coiled pipes can be crooked. However, it is difficult to twist or retract the coiled pipes. In other words, the extent of moving the water-cooling radiator or the water-cooling head is limited.

In addition to the coiled pipes, PVC pipes are widely used as the conduits. The PVC pipes can be crooked or twisted. However, since the environmental awareness gradually rises, the PVC plastic materials are readily prohibited because they do not meet environmental regulations.

Therefore, there is a need of providing a conduit that is made of appropriate material in order to replace the existing PVC pipe.

### SUMMARY OF THE INVENTION

For solving the drawbacks of the conventional liquid cooling device using coiled pipes or PVC pipes, the present invention provides a liquid cooling device with improved conduits. The liquid cooling device of the present invention can be installed flexibly and conveniently while meeting the environmental regulations.

In accordance with an aspect of the present invention, there is provided a liquid cooling device. The liquid cooling device includes a water-cooling head, a water-cooling radiator and plural conduits. The water-cooling head is contacted with a heat source. The water-cooling head includes a first inlet and a first outlet. The water-cooling radiator includes a second inlet and a second outlet. The plural conduits are in communication with the first outlet and second inlet and in communication with the first inlet and second outlet. Consequently, a circulation loop is constituted by the water-cooling head, the water-cooling radiator and the plural conduits collaboratively. Moreover, at least one conduit of the plural conduits is selected from ethylene propylene diene monomer (EPDM) rubber, epichlorohydrin (ECO) rubber, acrylic rubber (ACM), high-temperature ethylene acrylic rubber (AEM) or fluoroelastomer (FKM) rubber.

In an embodiment, the liquid cooling device further includes a working liquid and a pump. The working liquid is filled in the circulation loop. The pump is installed in the circulation loop to drive the working liquid to flow within the circulation loop. The pump is arranged between the second outlet and the first inlet.

In an embodiment, the liquid cooling device further includes a fastening element. The fastening element is sheathed around an outer periphery of the at least one conduit.

In accordance with another aspect of the present invention, there is provided a liquid cooling device. The liquid cooling device includes a water-cooling head, a water-cooling radiator and plural conduits. The water-cooling head is contacted with a heat source. The water-cooling head includes a first inlet and a first outlet. The water-cooling radiator includes a second inlet and a second outlet. The plural conduits are in communication with the first outlet and second inlet and in communication with the first inlet and second outlet. Consequently, a circulation loop is constituted by the water-cooling head, the water-cooling radiator and the plural conduits collaboratively. Moreover, at least one conduit of the plural conduits has a non-linear profile with at least one bent structure before installed on the water-cooling radiator or the water-cooling head.

In an embodiment, the at least one conduit has the at least one bent structure when the at least one conduit is produced.

In an embodiment, the liquid cooling device further includes a fastening element. The fastening element is sheathed around an outer periphery of the at least one conduit.

In an embodiment, the liquid cooling device further includes a working liquid and a pump. The working liquid is filled in the circulation loop. The pump is installed in the circulation loop to drive the working liquid to flow within the circulation loop, wherein the pump is arranged between the second outlet and the first inlet.

In accordance with a further aspect of the present invention, there is provided a liquid cooling device. The liquid cooling device includes a water-cooling head, a water-cooling radiator and plural conduits. The water-cooling head is contacted with a heat source. The water-cooling head includes a first inlet and a first outlet. The water-cooling radiator includes a second inlet and a second outlet. The plural conduits are in communication with the first outlet and second inlet and in communication with the first inlet and second outlet. Consequently, a circulation loop is constituted by the water-cooling head, the water-cooling radiator and the plural conduits collaboratively. Moreover, at least one conduit of the plural conduits has at least one retractable part.

In an embodiment, the retractable part is a combination of an outwardly-turned sleeve and an inwardly-folded sleeve.

In an embodiment, the retractable part is a combination of an outwardly-turned sleeve, an inwardly-folded sleeve and a tube structure in sequence.

In an embodiment, the liquid cooling device further includes a fastening element. The fastening element is sheathed around an outer periphery of the at least one conduit.

In an embodiment, the liquid cooling device further includes a working liquid and a pump. The working liquid is filled in the circulation loop. The pump is installed in the circulation loop to drive the working liquid to flow within the circulation loop. The pump is arranged between the second outlet and the first inlet.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates the architecture of a conventional liquid cooling device;

FIG. 1B is a schematic side view illustrating a portion of the conventional liquid cooling device;

FIGS. 2A˜2D schematically illustrate the architecture of a liquid cooling device and associated components according to a first embodiment of the present invention;

FIGS. 3A˜3D schematically illustrate the architecture of a liquid cooling device and associated components according to a second embodiment of the present invention; and

FIGS. 4A˜4F schematically illustrate the architecture of a liquid cooling device and associated components according to a third embodiment of the present invention.

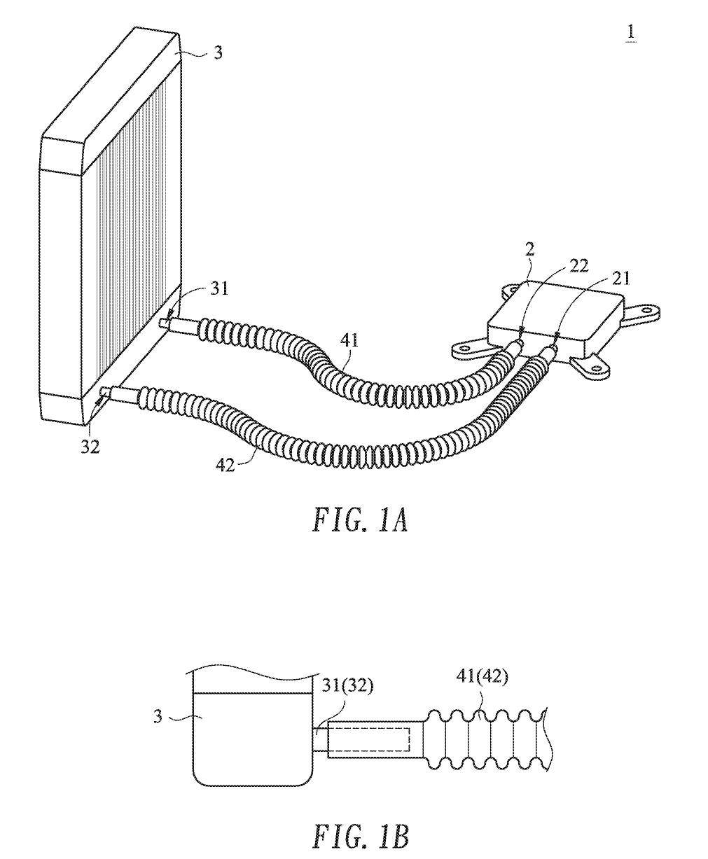

### DETAILED DESCRIPTION OF THE PREFERRED EMBODIMENT

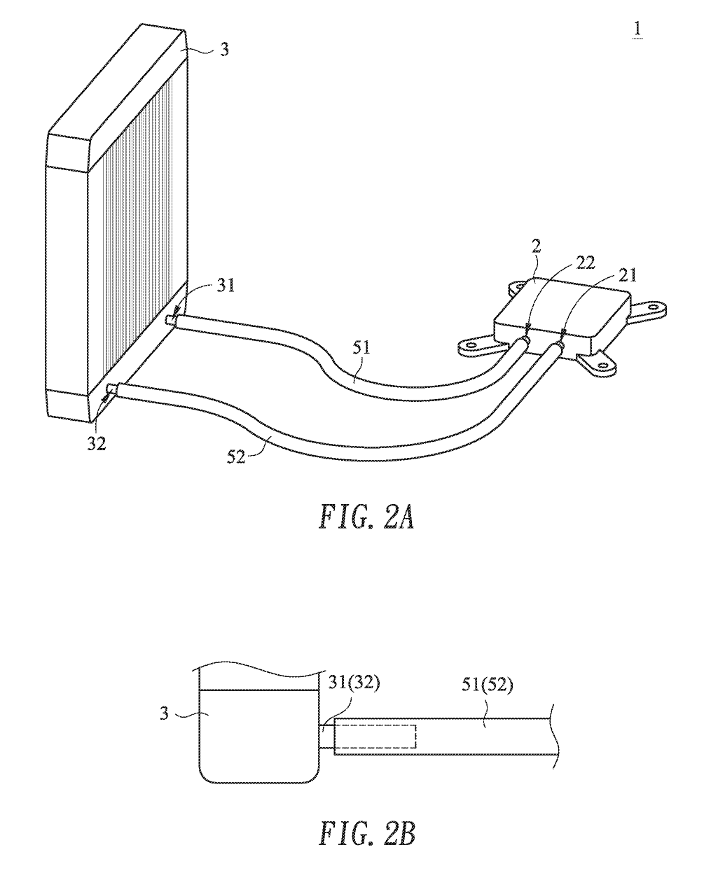

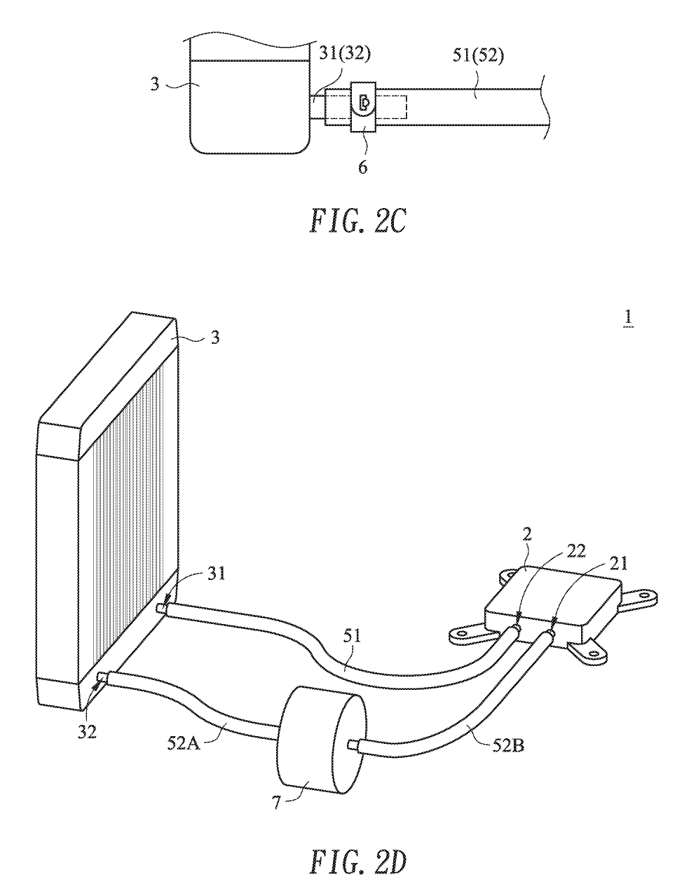

FIGS. 2A˜2D schematically illustrate the architecture of a liquid cooling device and associated components according to a first embodiment of the present invention. In this embodiment, the materials of the conduits of the liquid cooling device are improved and specially designed. As shown in FIGS. 2A˜2D, the liquid cooling device 1 comprises a water-cooling head 2, a water-cooling radiator 3 and plural conduits. The water-cooling head 2 is in contact with a heat source such as a central processing unit (CPU), a graphics processing unit (GPU), a chip or any other comparable device. After the heat from the heat source is absorbed by the water-cooling head 2, the heat is transferred to the water-cooling radiator 3 through a working liquid within a conduit 51. The water-cooling head 2 comprises an inlet 21 and an outlet 22. The water-cooling radiator 3 comprises an inlet 31 and an outlet 32. The plural conduits comprise the conduit 51 and a conduit 52. The conduit 51 is in communication with the outlet 22 of the water-cooling head 2 and the inlet 31 of the water-cooling radiator 3. The conduit 52 is in communication with the outlet 32 of the water-cooling radiator 3 and the inlet 21 of the water-cooling head 2. Moreover, a circulation loop is constituted by the water-cooling head 2, the water-cooling radiator 3 and the conduits 51 and 52 collaboratively.

After repeated tests and studies were made by the applicant, five suitable rubbery materials were selected as the materials of the conduits 51 and 52. These five rubbery materials include ethylene propylene diene monomer (EPDM) rubber, epichlorohydrin (ECO) rubber, acrylic rubber (ACM), high-temperature ethylene acrylic rubber (AEM) and fluoroelastomer (FKM) rubber. These rubbery materials have good heat resistance and aging resistance and excellent softness and oil resistance. In other words, these rubbery materials are suitably applied to the liquid cooling device and capable of meeting the environmental regulations.

Since the conduits 51 and 52 are made of rubbery materials, the hardness of the conduits 51 and 52 is lower than coiled pipes. In other words, the conduits 51 and 52 can be crooked or twisted. Optionally, as shown in FIG. 2C, one or more fastening elements 6 are sheathed around the outer periphery of the conduit 51 and/or 52. The uses of the fastening elements 6 can facilitate fixing the junctions between the inlets 21, 31 and the conduits 51, 52 and the junctions between the inlets 22, 32 and the conduits 51, 52. Consequently, the conduits 51 and 52 are not loosened.

As mentioned above, the liquid cooling device 1 comprises the water-cooling head 2, the water-cooling radiator 3 and the plural conduits. Optionally, the liquid cooling device 1 is additionally equipped with a pump or a water tank. As shown in FIG. 2D, a pump 7 is arranged between the outlet 32 of the water-cooling radiator 3 and the inlet 21 of the water-cooling head 2 for driving the working liquid. Consequently, the working liquid can flow within the circulation loop smoothly. The conduit 51 between the water-cooling head 2 and the water-cooling radiator 3, the conduit 52A between the water-cooling radiator 3 and the pump 7 and the conduit 52B between the pump 7 and the water-cooling head 2 are made of a rubbery material such as ethylene propylene diene monomer (EPDM) rubber, epichlorohydrin (ECO) rubber, acrylic rubber (ACM), high-temperature ethylene acrylic rubber (AEM) and fluoroelastomer (FKM) rubber.

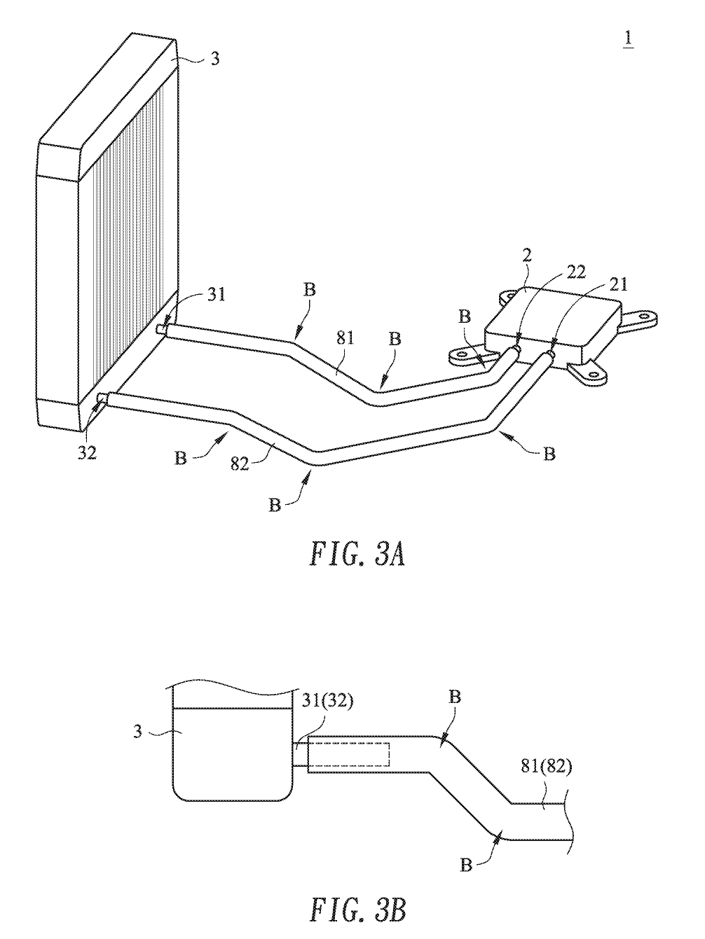

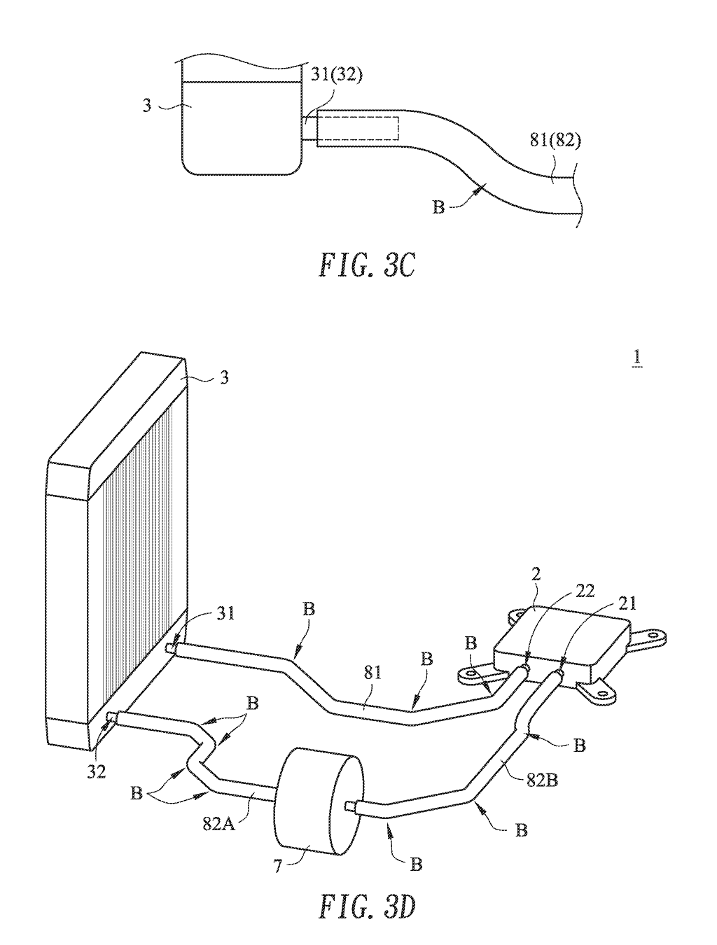

FIGS. 3A˜3D schematically illustrate the architecture of a liquid cooling device and associated components according to a second embodiment of the present invention. In this embodiment, the structures of the conduits of the liquid cooling device are improved and specially designed. As shown in FIGS. 3A˜3D, the liquid cooling device 1 comprises a water-cooling head 2, a water-cooling radiator 3 and plural conduits. The water-cooling head 2 is in contact with a heat source such as a central processing unit (CPU), a graphics processing unit (GPU), a chip or any other comparable device. After the heat from the heat source is absorbed by the water-cooling head 2, the heat is transferred to the water-cooling radiator 3 through a working liquid within a conduit 81. The water-cooling head 2 comprises an inlet 21 and an outlet 22. The water-cooling radiator 3 comprises an inlet 31 and an outlet 32. The plural conduits comprise the conduit 81 and a conduit 82. The conduit 81 is in communication with the outlet 22 of the water-cooling head 2 and the inlet 31 of the water-cooling radiator 3. The conduit 82 is in communication with the outlet 32 of the water-cooling radiator 3 and the inlet 21 of the water-cooling head 2. Moreover, a circulation loop is constituted by the water-cooling head 2, the water-cooling radiator 3 and the conduits 81 and 82 collaboratively.

As previously described, the conventional linear conduit is turned into the crooked state when the conduit is installed on the water-cooling head and the water-cooling radiator. Moreover, if the conventional conduit is bent or twisted during the moving process, the conventional conduit is easily shifted or loosened. When the conduit of the present invention is produced or before the conduit of the present invention is installed on the water-cooling head and the water-cooling radiator, the conduit is a non-linear conduit with at least bent structure B. For temporarily adjusting the location of the water-cooling head 2 or the water-cooling radiator 3 of the liquid cooling device 1, the force resulting in deformation of the conduit 81 or 82 is alleviated or absorbed by the bent structure B. Consequently, the joint between the water-cooling head 2 or the water-cooling radiator 3 and the conduit 81 or 82 (e.g., the joint between the inlet 21, 31 or the outlet 22, 32 and the conduit 81 or 82) is maintained in the secure connection state.

In this embodiment, each of the conduits 81 and 82 comprises at least one bent structure B. The profile of the bent structure B is not restricted. For example, the bent structure B as shown in FIG. 3B has an included angle, and the bent structure B as shown in FIG. 3C has a rounded corner.

Like the first embodiment, one or more fastening elements are optionally sheathed around the outer periphery of the conduit 81 and/or 82. The use of the fastening elements can facilitate fixing the junctions between the inlets 21, 31 and the conduits 81, 82 and the junctions between the inlets 22, 32 and the conduits 81, 82. Consequently, the conduits 81 and 82 are not loosened.

As mentioned above, the liquid cooling device 1 comprises the water-cooling head 2, the water-cooling radiator 3 and the plural conduits. Optionally, the liquid cooling device 1 is additionally equipped with a pump or a water tank. As shown in FIG. 3D, a pump 7 is arranged between the outlet 32 of the water-cooling radiator 3 and the inlet 21 of the water-cooling head 2 for driving the working liquid. Consequently, the working liquid can flow within the circulation loop smoothly. In this embodiment, the conduit 81 is arranged between the water-cooling head 2 and the water-cooling radiator 3, the conduit 82A is arranged between the water-cooling radiator 3 and the pump 7 and the conduit 82B is arranged between the pump 7 and the water-cooling head 2. When the conduit of the present invention is produced or before the conduit of the present invention is installed on the water-cooling head and the water-cooling radiator, the conduit is a non-linear conduit with at least bent structure B. For temporarily adjusting the location of the water-cooling head 2, the water-cooling radiator 3 or the pump 7, the force resulting in deformation of the conduit 81, 82A or 82B is alleviated or absorbed by the bent structure B.

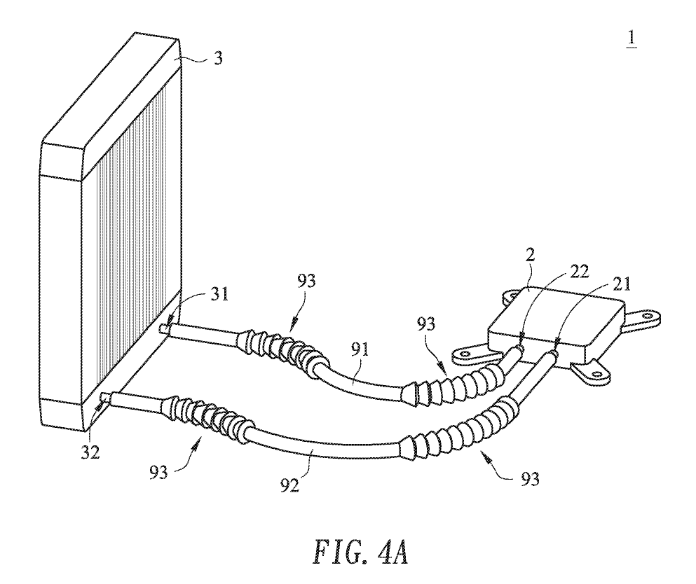

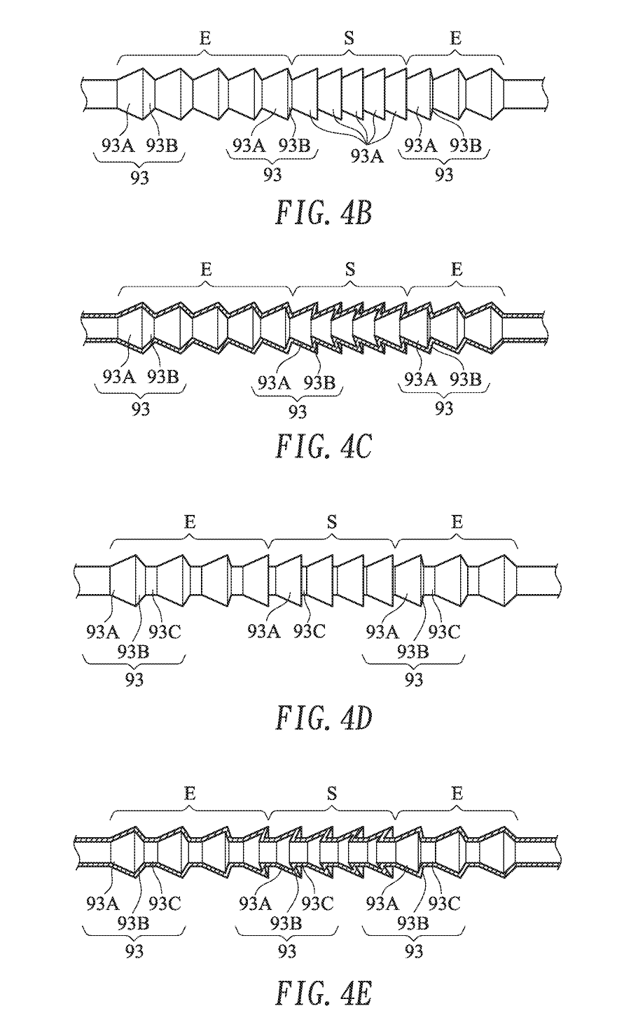

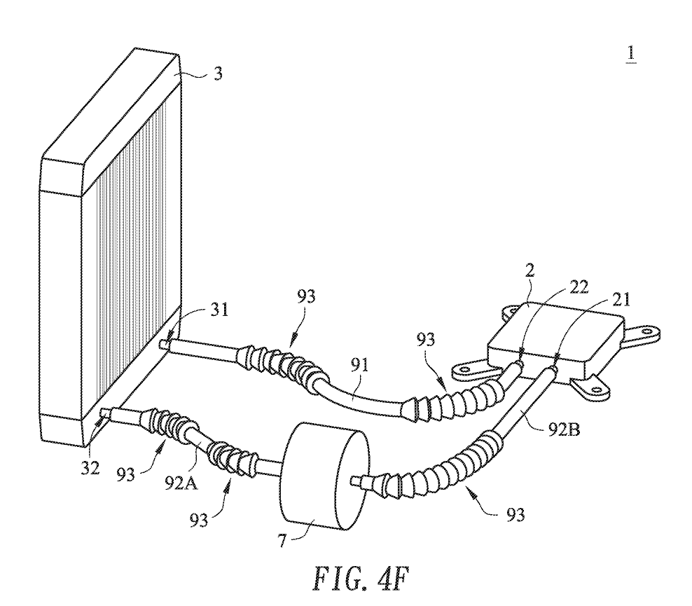

FIGS. 4A˜4F schematically illustrate the architecture of a liquid cooling device and associated components according to a third embodiment of the present invention. In this embodiment, the structures of the conduits of the liquid cooling device are improved and specially designed. As shown in FIGS. 3A-3F, the liquid cooling device 1 comprises a water-cooling head 2, a water-cooling radiator 3 and plural conduits. The water-cooling head 2 is in contact with a heat source such as a central processing unit (CPU), a graphics processing unit (GPU), a chip or any other comparable device. After the heat from the heat source is absorbed by the water-cooling head 2, the heat is transferred to the water-cooling radiator 3 through a working liquid within a conduit 91. The water-cooling head 2 comprises an inlet 21 and an outlet 22. The water-cooling radiator 3 comprises an inlet 31 and an outlet 32. The plural conduits comprise the conduit 91 and a conduit 92. The conduit 91 is in communication with the outlet 22 of the water-cooling head 2 and the inlet 31 of the water-cooling radiator 3. The conduit 92 is in communication with the outlet 32 of the water-cooling radiator 3 and the inlet 21 of the water-cooling head 2. Moreover, a circulation loop is constituted by the water-cooling head 2, the water-cooling radiator 3 and the conduits 91 and 92 collaboratively.

For allowing the conduits 91 and 92 to be retracted freely, each of the conduits 91 and 92 is equipped with at least one retractable part 93. Due to the retractable part 93, the movement of the water-cooling head 2 or the water-cooling radiator 3 is not limited and constrained by the original lengths of the conduits 91 and 92. The retractable part 93 comprises an outwardly-turned sleeve 93A and an inwardly-folded sleeve 93B. The outwardly-turned sleeve 93A and the inwardly-folded sleeve 93B are connected with each other. When the retractable part 93 is stretched and the length is extended, both of the outwardly-turned sleeve 93A and the inwardly-folded sleeve 93B are exposed. When the retractable part 93 is compressed and the length is shortened, the outwardly-turned sleeve 93A is still exposed but the inwardly-folded sleeve 93B is inwardly folded and partially hidden in the outwardly-turned sleeve 93A.

FIG. 4B schematically illustrates the outer appearance of plural retractable parts 93. In FIG. 4B, the segment E indicates the stretched retractable parts 93, and the segment S indicates the compressed retractable parts 93. FIG. 4C is a schematic cross-sectional view illustrating the retractable parts 93. The outwardly-turned sleeve 93A and the inwardly-folded sleeve 93B of the retractable part 93 in the stretched state and the compressed state are shown in FIG. 4C. In the segment S, the inwardly-folded sleeve 93B is inwardly folded and partially hidden in the outwardly-turned sleeve 93A.

In the above example, the retractable part 93 of the conduit 91 or 92 comprises the outwardly-turned sleeve 93A and the inwardly-folded sleeve 93B. The outwardly-turned sleeve 93A and the inwardly-folded sleeve 93B are connected with each other.

The example of the retractable part 93 is not restricted. As shown in FIG. 4D, the retractable part 93 is the combination of an outwardly-turned sleeve 93A, an inwardly-folded sleeve 93B and a tube structure 93C. When the retractable part 93 is stretched and the length is extended, the outwardly-turned sleeve 93A, the inwardly-folded sleeve 93B and the tube structure 93C are all exposed. When the retractable part 93 is compressed and the length is shortened, the outwardly-turned sleeve 93A is still exposed, the inwardly-folded sleeve 93B is inwardly folded and partially hidden in the outwardly-turned sleeve 93A, and the tube structure 93C is partially hidden in the outwardly-turned sleeve 93A. FIG. 4D schematically illustrates the outer appearance of plural retractable parts 93. In FIG. 4D, the segment E indicates the stretched retractable parts 93, and the segment S indicates the compressed retractable parts 93. FIG. 4E is a schematic cross-sectional view illustrating the retractable parts 93. The outwardly-turned sleeve 93A, the inwardly-folded sleeve 93B and the tube structure 93C of the retractable part 93 in the stretched state and the compressed state are shown in FIG. 4E. In the segment S, the inwardly-folded sleeve 93B is inwardly folded and partially hidden in the outwardly-turned sleeve 93A, and the tube structure 93C is partially hidden in the outwardly-turned sleeve 93A.

Like the first embodiment, one or more fastening elements are optionally sheathed around the outer periphery of the conduit 91 and/or 92. The use of the fastening elements can facilitate fixing the junctions between the inlets 21, 31 and the conduits 91, 92 and the junctions between the inlets 22, 32 and the conduits 91, 92. Consequently, the conduits 91 and 92 are not loosened.

As mentioned above, the liquid cooling device 1 comprises the water-cooling head 2, the water-cooling radiator 3 and the plural conduits. Optionally, the liquid cooling device 1 is additionally equipped with a pump or a water tank. As shown in FIG. 4F, a pump 7 is arranged between the outlet 32 of the water-cooling radiator 3 and the inlet 21 of the water-cooling head 2 for driving the working liquid. Consequently, the working liquid can flow within the circulation loop smoothly. In this embodiment, the conduit 91 is arranged between the water-cooling head 2 and the water-cooling radiator 3, the conduit 92A is arranged between the water-cooling radiator 3 and the pump 7 and the conduit 92B is arranged between the pump 7 and the water-cooling head 2. For allowing the conduits 91 and 92 to be retracted freely, each of the conduits 91 and 92 is equipped with at least one retractable part 93. Due to the retractable part 93, the movement of the water-cooling head 2 or the water-cooling radiator 3 is not limited and constrained by the original lengths of the conduits 91, 92A and 92B.

1. A liquid cooling device, comprising:
a water-cooling head contacted with a heat source, wherein the water-cooling head comprises a first inlet and a first outlet;
a water-cooling radiator comprising a second inlet and a second outlet; and
plural conduits in communication with the first outlet and second inlet and in communication with the first inlet and second outlet, so that a circulation loop is constituted by the water-cooling head, the water-cooling radiator and the plural conduits collaboratively,
wherein at least one conduit of the plural conduits is selected from epichlorohydrin (ECO) rubber, acrylic rubber (ACM), ethylene acrylic rubber (AEM) or fluoroelastomer (FKM) rubber.

2. The liquid cooling device according to claim 1, further comprising:
a working liquid filled in the circulation loop; and
a pump installed in the circulation loop to drive the working liquid to flow within the circulation loop, wherein the pump is arranged between the second outlet and the first inlet.

3. The liquid cooling device according to claim 1, further comprising a fastening element, wherein the fastening element is sheathed around an outer periphery of the at least one conduit.

4. (canceled)

5. (canceled)

6. (canceled)

7. (canceled)

8. A liquid cooling device, comprising:
a water-cooling head contacted with a heat source, wherein the water-cooling head comprises a first inlet and a first outlet;
a water-cooling radiator comprising a second inlet and a second outlet; and
plural conduits in communication with the first outlet and second inlet and in communication with the first inlet and second outlet, so that a circulation loop is constituted by the water-cooling head, the water-cooling radiator and the plural conduits collaboratively,
wherein at least one conduit of the plural conduits has at least one retractable part, the retractable part is a combination of an outwardly-turned sleeve and an inwardly-folded sleeve, when the retractable part is compressed and the length is shortened, the outwardly-turned sleeve is still exposed but the inwardly-folded sleeve is inwardly folded and partially hidden in the outwardly-turned sleeve.

9. (canceled)

10. (canceled)

11. The liquid cooling device according to claim 8, further comprising a fastening element, wherein the fastening element is sheathed around an outer periphery of the at least one conduit.

12. The liquid cooling device according to claim 8, further comprising:
a working liquid filled in the circulation loop; and
a pump installed in the circulation loop to drive the working liquid to flow within the circulation loop, wherein the pump is arranged between the second outlet and the first inlet.
